(19) United States
(12) Patent Application Publication
(10) Pub. No.: US 2017/0004316 A1
(43) Pub. Date: Jan. 5, 2017

(54) ALTERNATE CLIPBOARD FOR SECURE APPLICATIONS

(71) Applicant: AppSense Limited, Warrington (GB)

(72) Inventor: Travis WALTON, Bolton (GB)

(21) Appl. No.: 14/790,937

(22) Filed: Jul. 2, 2015

(51) Int. Cl. G06F 21/62

(52) U.S. Cl. CPC G06F 21/6209

(57) ABSTRACT

Systems and methods are described for clipboard intercession of secure applications. Techniques include a method for clipboard intercession comprising: for a first application, the application having a first library that includes a function referencing a first memory location for at least one clipboard command associated with the application, modifying the application such that a second, different memory location is referenced when the function is called for the at least one clipboard command; in response to the first application receiving a copy command, copying first text to the second memory location and not the first memory location; and, in response to a second application receiving a paste command after the first application receives the copy command, referencing the first memory location and not the second memory location such that the first text is not accessed by the second application.

### TECHNICAL FIELD

This application relates generally to data security, and more specifically to tools for preventing sensitive data leakage through computer system clipboard functionality.

### BACKGROUND

Existing software allows for restrictions to be applied to the use of secure files. A file can be kept encrypted on disk and the user restricted in how, where and when they can open this file. However, all of this is for nothing if the user can just copy and paste the content of the file into a separate, insecure file. On many operating systems, the system provides a library that allows applications running on that system to easily provide copy-and-paste facilities in a manner consistent with the rest of the system.

A known method of clipboard security is to periodically check the contents of the clipboard and eliminate any sensitive data. However, because this method is not tied to the actual use of the clipboard, the system may either check too infrequently (missing secure data transfer) or may check too frequently (overconsuming system resources). A need therefore exists for a software feature that maintains existing cut-and-paste functionality while assuring that secure data cannot leave secure applications.

### SUMMARY

In accordance with the disclosed subject matter, systems and methods are described for providing an alternate clipboard accessible to secure applications.

Disclosed subject matter includes, in one aspect: for a first application, the application having a first library that includes a function referencing a first memory location for at least one clipboard command associated with the application, modifying the application such that a second, different memory location is referenced when the function is called for the at least one clipboard command; in response to the first application receiving a copy command, copying first text to the second memory location and not the first memory location; and, in response to a second application receiving a paste command after the first application receives the copy command, referencing the first memory location and not the second memory location such that the first text is not accessed by the second application.

In some embodiments, modifying the application can include adding a dynamic library to the application, the dynamic library overriding the first library with respect to the function.

In some embodiments, the method can further comprise: modifying a third application such that the second memory location is referenced when a clipboard command is received by the third application; and, in response to the third application receiving a paste command after the first application receives the copy command, referencing the second memory location such that the first text is accessed by the third location.

In some embodiments, the method can further comprise identifying the application as a secure application prior to modifying the application.

In another aspect, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In another aspect, the techniques may be realized as a system comprising one or more processors communicatively coupled to a network; wherein the one or more processors are configured to carry out any and all of the steps described with respect to any of the above embodiments.

Various embodiments of the subject matter disclosed herein can provide one or more of the following capabilities. The system clipboard feature can no longer be used to remove secure data from secure applications modified according to embodiments described herein. However, secure data can still be moved within a secure application or between secure applications using the same commands as before and without any additional steps being taken by the user.

These and other capabilities of embodiments of the disclosed subject matter will be more fully understood after a review of the following figures, detailed description, and claims.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a block diagram showing insecure and secure applications in accordance with some embodiments.

FIG. 2 is a flowchart illustrating a clipboard intercession method in accordance with some embodiments.

FIGS. 3A-3E illustrate a series of copy-and-paste commands on a client system in accordance with some embodiments.

FIG. 4 illustrates a block diagram of an exemplary computing device in accordance with some embodiments

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

A method of limiting copy-and-paste to secure applications is disclosed. In place of the standard library calls by which a common memory location is named and used for clipboard functionality, a dynamic library is inserted into the secure application which includes a library call to a different memory location. Thus, among the one or more secure applications for which this modification is carried out, effectively an independent clipboard is used that is not accessible by applications outside of the secure applications.

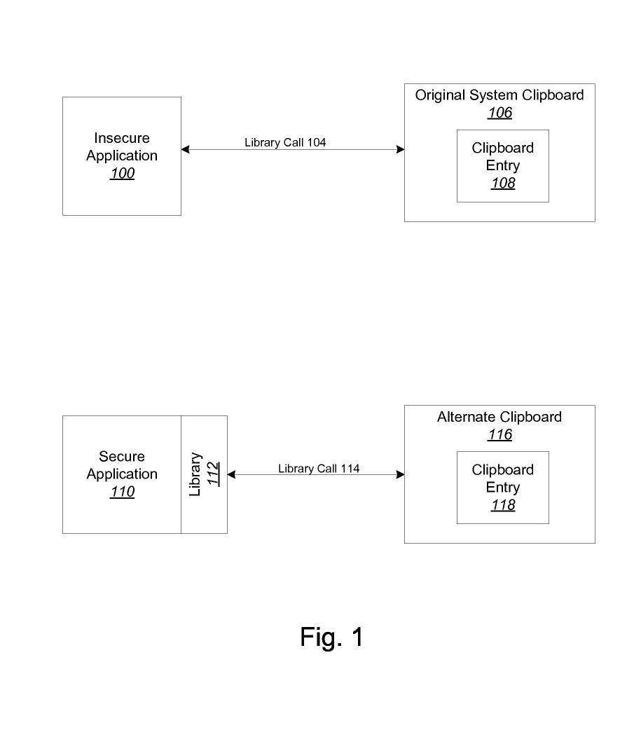

FIG. 1 illustrates the distinction. As shown, an insecure application 100 having a standard library uses a standard library call 104 referencing the standard memory location for the original system clipboard 106. A clipboard entry 108 introduced by calls from the application 100 and other insecure applications can be moved between these applications.

However, the secure application 110 has an introduced dynamic library 112 which provides a different reference for the memory location. A clipboard command thus results in a library call 114 referring to a different memory location associated with an alternate clipboard 116. A clipboard entry 118 generated by the application 110 or any other secure application is only accessible to applications with library calls to the alternate clipboard 116.

Copy-and-paste commands within the insecure application 100 only concern the original system clipboard 106 and cannot access the alternate clipboard 116; similarly, copy-and-paste commands within the secure application 110 only concern the alternate clipboard 116 and cannot access the original system clipboard 106. Therefore, the insecure application 100 does not have access to the clipboard entry 118 or any clipboard entry generated in a secure application.

In some implementations, where multiple secure applications each include a dynamic library with a call to the same alternate memory location for the alternate clipboard, it is therefore possible to copy data between these secure applications. In other implementations, different alternate memory locations may be given for some different secure applications, such as those having different levels of security. By allocating different clipboards to different programs, the system can manage to what extent data can be easily transferred between these programs.

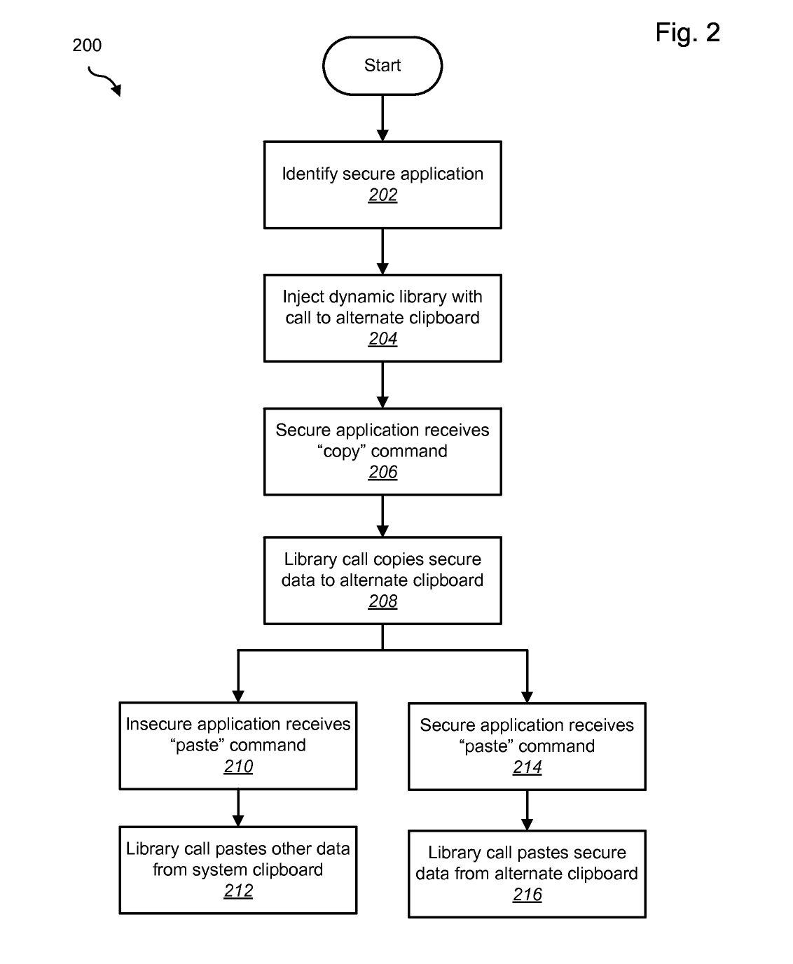

FIG. 2 is a flowchart illustrating a method 200 for clipboard intercession in accordance with the present invention.

The system identifies a secure application for which clipboard intercession is desired (202). In some implementations, this will be an application with known controls on data egress such as restrictions on file copying and saving. In some implementations, multiple secure applications may be identified such that, by similar modification for clipboard intercession, copy-and-paste between the secure applications may be allowed.

In the exemplary embodiment, it is presumed that the secure application includes a library with a call which references a common system clipboard location. For example, a common C-language library function “shm_open” is used by some applications to access the clipboard. Standard libraries included in many applications written for a particular operating systems will include a common reference for the “shm_open” function such that each “shm_open” library call results in an operation on the same shared memory location.

For the secure application, this library call is altered by the injection of a dynamic library which associated the same function with a different reference location (204). So, instead of a call to the library function resulting in an operation on the shared memory location (the original system clipboard), a newly-specified memory location (the alternate clipboard) is manipulated instead.

A “copy” command received by a secure application (that is, one for which the earlier steps 202 and 204 have been carried out) results in data from the secure application (“secure data”) being copied to the alternate clipboard (206 and 208). Subsequently, a “paste” command from an insecure application (that is, one for which the earlier steps 202 and 204 have not been carried out) will return only whatever data is in the system clipboard, which will NOT be the secure data (210 and 212). In contrast, a subsequent “paste” command from a secure application will return the secure data from the alternate clipboard (214 and 216). In this way, data can be copied between secure applications but not outside of the set of secure applications using the clipboard commands.

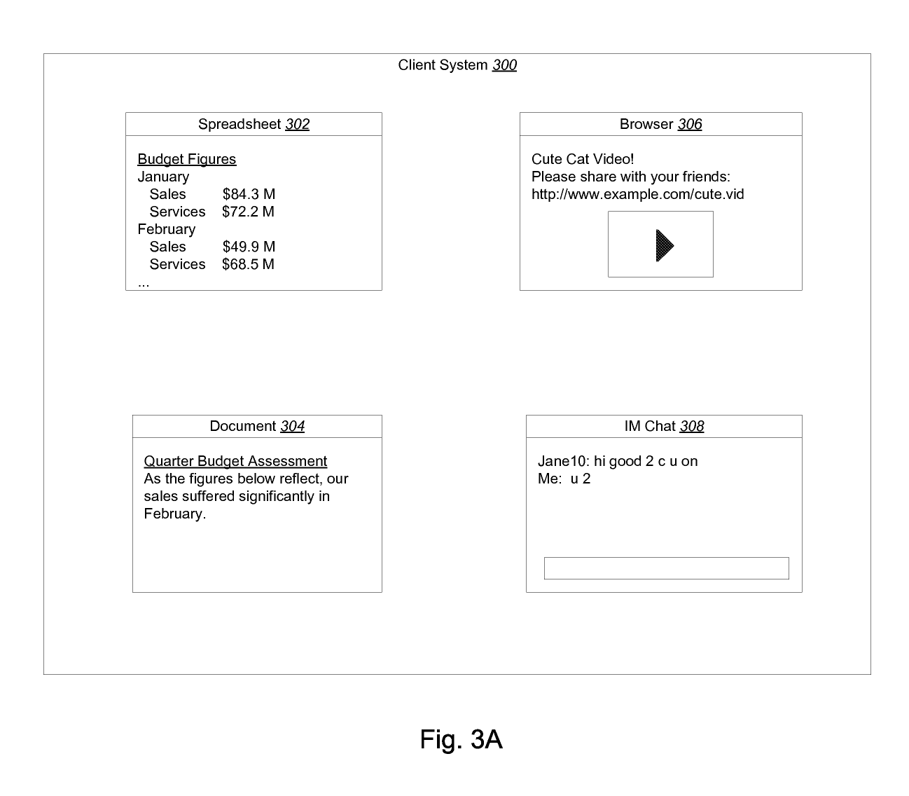

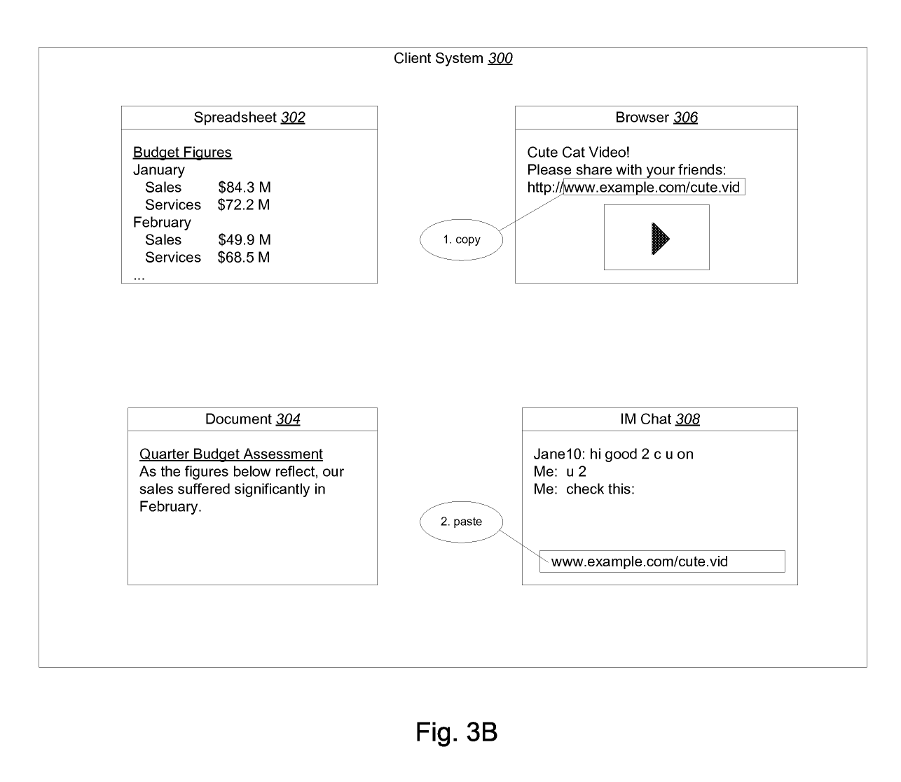

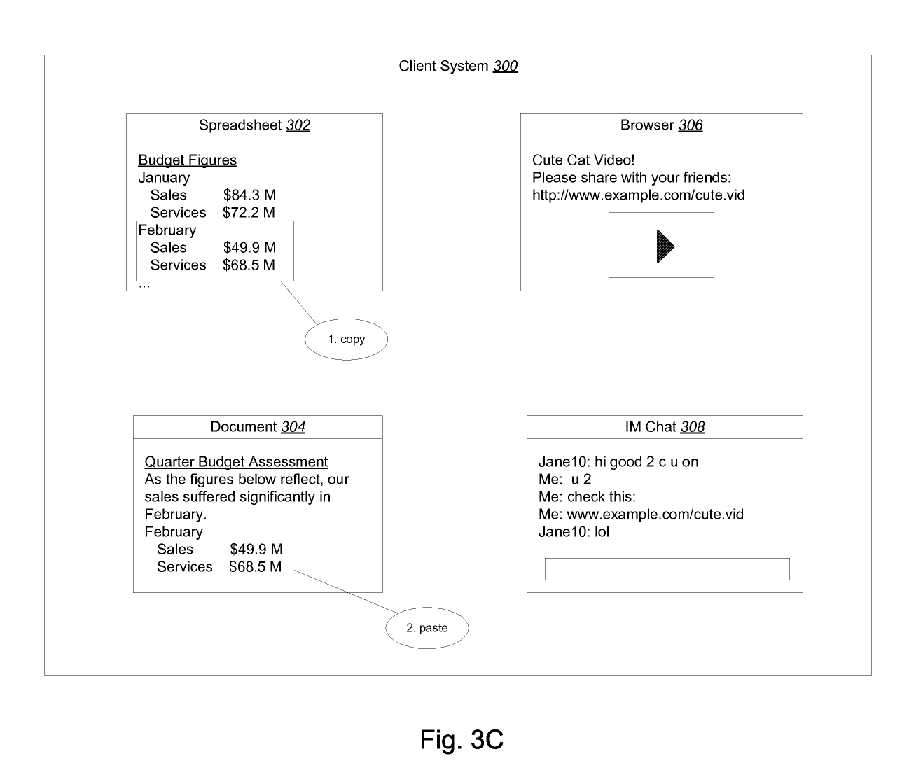

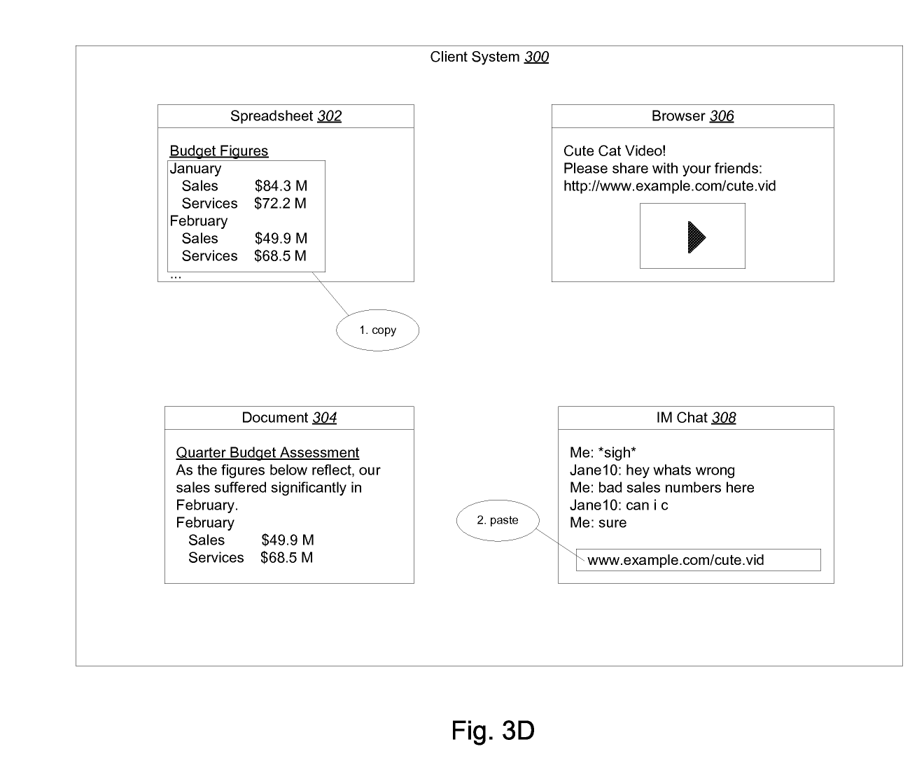

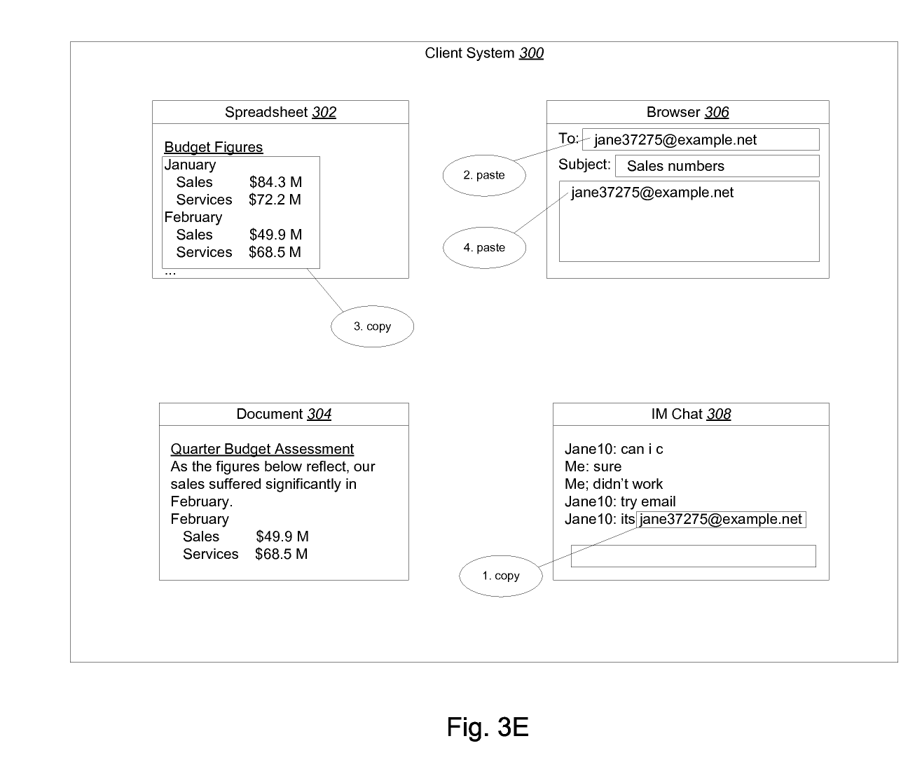

FIGS. 3A-E illustrate a series of copy-and-paste actions using a set of applications available to a user of a client system 300. The user has windows open associated with four applications: a secure spreadsheet application 302, a secure document editing application 304, an insecure internet browsing application 306, and an insecure instant messaging application 308. In accordance with embodiments described herein, all four of these applications have access to copy-and-paste functionality which would usually refer to a common system clipboard. The secure applications 302 and 304 have been modified so copy-and-paste commands will result in function calls that refer instead to an alternate clipboard, while the insecure applications 306 and 308 have not been modified and will continue to refer to the standard system clipboard.

As shown in FIG. 3B, the user decides to share a URL for a cat video with her friend. The user first uses the “copy” command in the browser window 306 highlighting the cat URL. The user then uses the “paste” command in the chat window 308. Because both of the insecure windows reference the system clipboard, the URL appears in the text entry portion of the chat window 308 as expected.

As shown in FIG. 3C, the user then decides to include the February statistics from the budget spreadsheet in a budget report that the user is preparing. The user first uses the “copy” command in the spreadsheet window 302 while highlighting the February figures. The user then uses the “paste” command in the document window 304. Because both of the secure windows reference the alternate clipboard, the statistics appear in the document as expected.

The user then attempts to share the data with her friend over chat, as shown in FIG. 3D. The user first uses the “copy” command highlighting the January and February data in the spreadsheet window 302. Then the “paste” command is used in the chat window 308. However, because the chat application is not referencing the alternate clipboard like the spreadsheet application, the result is not as the user expects—the last text copied to the system clipboard (in this case, the cat video URL) is copied as well.

The user makes one more attempt to share the secure data with her friend, this time by emailing her the data by means of the browser window 306, as shown in FIG. 3E. First, she highlights and copies her friend's email address in the chat window 308, pasting it to the address block in the browser window 306. Again, because these insecure applications are both referencing the system clipboard, the address is copied as expected.
The user then highlights and copies the sales data from the spreadsheet 302. Returning to the browser window, the user uses the “paste” command into the email body. However, again, what is pasted is the last text that was copied into the system clipboard, which is the friend's email address.

As illustrated in FIGS. 3A-3E, the user has been prevented twice from copying secure data into insecure applications, and presumably sharing them beyond established procedures. Implementations of the present disclosure can reliably and effectively prevent both intentional and inadvertent leakage of secure information by means of the system clipboard.

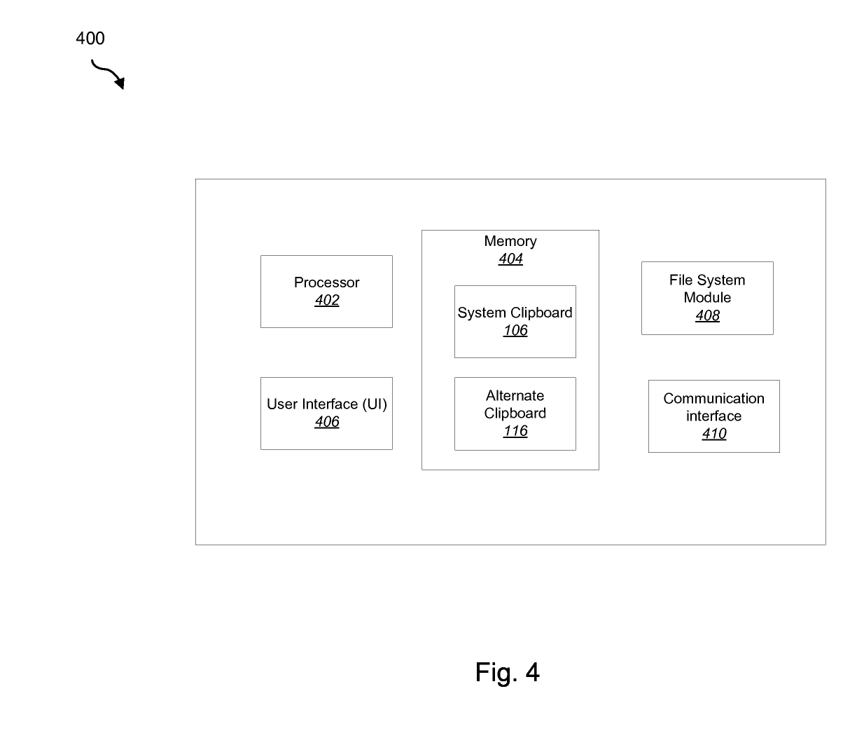

FIG. 4 illustrates a block diagram of an exemplary computing device 400 according to certain embodiments of the disclosed subject matter. The computing device 400 can include at least one processor 402 and at least one memory 404. The processor 402 can be hardware that is configured to execute computer readable instructions such as software. The processor 402 can be a general processor or be an application specific hardware (e.g., an application specific integrated circuit (ASIC), programmable logic array (PLA), field programmable gate array (FPGA), or any other integrated circuit). The processor 402 can execute computer instructions or computer code to perform desired tasks. The memory 404 can be a transitory or non-transitory computer readable medium, such as flash memory, a magnetic disk drive, an optical drive, a programmable read-only memory (PROM), a read- only memory (ROM), a random access memory (RAM), or any other memory or combination of memories. A system clipboard 106 and alternate, secure clipboard 116, as described above, can reside at specific referenced memory locations.

The computing device 400 can also optionally include a user interface (UI) 406, a file system module 408, and a communication interface 410. The UI 406 can provide an interface for users to interact with the computing device 400 in order to access secure and insecure applications and to copy and paste data as described above. The file system module 408 can be configured to maintain a list of all data files, including both local data files and remote data files, in every folder in a file system. The file system module 408 can be further configured to coordinate with the memory 404 to store and cache files/data. The communication interface 410 can allow the computing device 400 to communicate with external resources (e.g., a network or a remote client/server). The computing device 400 can include additional components, fewer components, or any other suitable combination of components that perform any suitable operation or combination of operations.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

An “application” or “interface” is not software per se and includes at least some tangible, non-transitory hardware that is configured to execute computer readable instructions. In addition, the phrase “based on” does not imply exclusiveness—for example, if X is based on A, X can also be based on B, C, and/or D.

What is claimed is:

1. A computerized method for clipboard intercession comprising:
for a first application, the application having a first library that includes a function referencing a first memory location for at least one clipboard command associated with the application, modifying the application such that a second, different memory location is referenced when the function is called for the at least one clipboard command;
in response to the first application receiving a copy command, copying first text to the second memory location and not the first memory location; and
in response to a second application receiving a paste command after the first application receives the copy command, referencing the first memory location and not the second memory location such that the first text is not accessed by the second application.

2. The method of claim 1, wherein modifying the application comprises adding a dynamic library to the application, the dynamic library overriding the first library with respect to the function.

3. The method of claim 1, further comprising:
modifying a third application such that the second memory location is referenced when a clipboard command is received by the third application; and
in response to the third application receiving a paste command after the first application receives the copy command, referencing the second memory location such that the first text is accessed by the third location.

4. The method of claim 1, further comprising:
prior to modifying the application, identifying the application as a secure application.

5. At least one non-transitory processor readable storage medium storing a computer program of instructions configured to be readable by at least one processor for instructing the at least one processor to execute a computer process for performing the method as recited in claim 1.

6. An article of manufacture comprising:
at least one processor readable storage medium; and
instructions stored on the at least one medium;
wherein the instructions are configured to be readable from the at least one medium by at least one processor and thereby cause the at least one processor to operate so as to:
for a first application, the application having a first library that includes a function referencing a first memory location for at least one clipboard command associated with the application, modify the application such that a second, different memory location is referenced when the function is called for the at least one clipboard command;
in response to the first application receiving a copy command, copy first text to the second memory location and not the first memory location; and
in response to a second application receiving a paste command after the first application receives the copy command, reference the first memory location and not the second memory location such that the first text is not accessed by the second application.

7. The article of claim 6, wherein modifying the application comprises adding a dynamic library to the application, the dynamic library overriding the first library with respect to the function.

8. The article of claim 6, the at least one processor further operable to:
modify a third application such that the second memory location is referenced when a clipboard command is received by the third application; and
in response to the third application receiving a paste command after the first application receives the copy command, reference the second memory location such that the first text is accessed by the third location.

9. The article of claim 6, the at least one processor further operable to:
prior to modifying the application, identify the application as a secure application.

10. A system comprising one or more processors communicatively coupled to a network; wherein the one or more processors are configured to:
for a first application, the application having a first library that includes a function referencing a first memory location for at least one clipboard command associated with the application, modify the application such that a second, different memory location is referenced when the function is called for the at least one clipboard command;
in response to the first application receiving a copy command, copy first text to the second memory location and not the first memory location; and
in response to a second application receiving a paste command after the first application receives the copy command, reference the first memory location and not the second memory location such that the first text is not accessed by the second application.

11. The system of claim 10, wherein modifying the application comprises adding a dynamic library to the application, the dynamic library overriding the first library with respect to the function.

12. The system of claim 10, the one or more processors further configured to:
modify a third application such that the second memory location is referenced when a clipboard command is received by the third application; and
in response to the third application receiving a paste command after the first application receives the copy command, reference the second memory location such that the first text is accessed by the third location.

13. The system of claim 10, the one or more processors further configured to:
prior to modifying the application, identify the application as a secure application.
